(19) United States
(12) Patent Application Publication
(10) Pub. No.: US 2006/0209474 A1
(43) Pub. Date: Sep. 21, 2006

(54) Magneto-resistive head

(75) Inventor: Junichi Hashimoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/175,941

(22) Filed: Jul. 6, 2005

(30) Foreign Application Priority Data
Mar. 17, 2005 (JP) 2005-77454

(51) Int. Cl. G11B 5/33; G11B 5/127

(52) U.S. Cl. 360/324.12

(57) ABSTRACT

In a magneto-resistive head, the magnetic orientation of magnetic domain control layers is stabilized to pin the bias magnetic field that acts on the free layer of a magneto-resistive film, thereby suppressing the production of noise such as Barkhausen noise and enabling the magneto-resistive head to operate stably. A CPP-type magneto-resistive head includes a magneto-resistive element, a lower electrode layer and an upper electrode layer disposed so as to sandwich the magneto-resistive element in a thickness direction, magnetic domain control layers that are disposed via insulating films on both sides of the magneto-resistive element and apply a bias magnetic field that controls a magnetic domain of the free layer provided in the magneto-resistive element, and antiferromagnetic layers that are laminated on the magnetic domain control layers and pin a bias magnetic field of the magnetic domain control layers.

### BACKGROUND OF THE INVENTION

1. Field of the Invention

The present invention relates to a magneto-resistive head, and in more detail to a CPP (Current Perpendicular to the Plane)-type magneto-resistive head.

2. Related Art

FIG. 7 shows the construction of a CPP-type magneto-resistive head when viewed from the floating surface-side of a head slider. This magneto-resistive head includes a magneto-resistive element 10, a lower electrode layer 12 and an upper electrode layer 14 disposed so as to sandwich the magneto-resistive element 10 in the thickness direction, and magnetic domain control layers 16a, 16b disposed so as to sandwich the magneto-resistive element 10 on both sides.

The lower electrode layer 12 and the upper electrode layer 14 are both composed of a soft magnetic material such as NiFe, and in addition to acting as magnetic shield layers, are used as current terminals for passing a current in a perpendicular direction to the surfaces where the layers 12, 14 are laminated on the magneto-resistive element 10. To electrically insulate the lower electrode layer 12 and the upper electrode layer 14 from one another, insulating layers 18a and 18b made of alumina or the like are provided across the upper surface of the lower electrode layer 12 from both side surfaces of the magneto-resistive element 10.

The magneto-resistive element 10 has a structure in which a pinned layer, a free layer, and the like are laminated. The magnetic domain control layers 16a, 16b are provided to apply a bias magnetic field to control the magnetic domain of the free layer so that the magnetic orientation of the free layer when no magnetic flux is acting is oriented toward the core width direction. To do so, a ferromagnetic material that exhibits permanent magnetism, such as CoCrPt or CoPt, is used for the magnetic domain control layers 16a, 16b.

Patent Document 1

Japanese Laid-Open Patent Publication No. H 11-316919

As described above, the magnetic domain control layers 16a, 16b are provided to orient the magnetic orientation of the free layer formed in the magneto-resistive element 10 to a predetermined standard direction (the core width direction). However, it is believed that due to the factors described later, the bias magnetic field due to the magnetic domain control layers 16a, 16b does not precisely act on the free layer, resulting in the risk of Barkhausen noise and the like being produced.

In other words, it is thought that since the magnetic domain control layers 16a, 16b are disposed on the sides of the magneto-resistive element 10 via the insulating layers 18a, 18b, the effect of the magnetic field that acts on the free layer of the magneto-resistive element 10 is suppressed.

Since the surfaces of the magnetic domain control layers 16a, 16b that face the magneto-resistive element 10 are formed as inclined surfaces, the orientation of the magnetic domain at the surfaces facing the magneto-resistive element 10 becomes non-uniform (unaligned). It is believed that this causes the bias magnetic field to not act precisely on the free layer. Since the bias magnetic field that acts on the free layer from the magnetic domain control layers 16a, 16b mainly acts on the end surfaces of the magneto-resistive element 10, the orientation of the magnetic domain at the end surfaces of the magnetic domain control layers 16a, 16b is important.

The lower electrode layer 12 and the upper electrode layer 14 are soft magnetic bodies, and the bias magnetic field that acts on the magneto-resistive element 10 via the lower electrode layer 12 and the upper electrode layer 14, and in particular the bias magnetic field that acts via the upper electrode layer 14 are also important. The bias magnetic field of the magnetic domain control layers 16a, 16b acts on the magneto-resistive element 10 via the lower electrode layer 12 and the upper electrode layer 14, but if the magnetic domain orientation of the magnetic domain control layers 16a, 16b becomes unstable, the bias magnetic field that acts on the magneto-resistive element 10 via the lower electrode layer 12 and the upper electrode layer 14 will also become unstable. This is believed to cause noise.

### SUMMARY OF THE INVENTION

The present invention was conceived in order to solve the problems described above and it is an object of the present invention to provide a magneto-resistive head, and in particular a CPP-type magneto-resistive head, where the magnetic orientation of magnetic domain control layers is stabilized so as to precisely orient the magnetic orientation of a free layer in a magneto-resistive film so that the production of noise such as Barkhausen noise can be suppressed and the head can operate more stably.

To achieve the stated object a magneto-resistive element according to the present invention is a CPP (Current Perpendicular to the Plane)-type magneto-resistive head including a magneto-resistive element; a lower electrode layer and an upper electrode layer disposed so as to sandwich the magneto-resistive element in a thickness direction; magnetic domain control layers that are disposed via insulating films on both sides of the magneto-resistive element and apply a bias magnetic field that controls a magnetic domain of a free layer provided in the magneto-resistive element; and antiferromagnetic layers that are laminated on the magnetic domain control layers and pin a bias magnetic field of the magnetic domain control layers.

A TMR element including a pinned layer, an insulating layer, and the free layer may be used as the magneto-resistive element.

A spin valve-type GMR element including a pinned layer, a non-magnetic intermediate layer, and the free layer may be used as the magneto-resistive element.

The antiferromagnetic layers may be magnetically coupled to the magnetic domain control layers via a first ferromagnetic layer, a non-magnetic layer, and a second ferromagnetic layer that are disposed at interfaces between the antiferromagnetic layers and the magnetic domain control layers to strengthen the magnetic coupling between the antiferromagnetic layers and the magnetic domain control layers.

The antiferromagnetic layers may be magnetically coupled to the upper electrode layer via a first ferromagnetic layer, a non-magnetic layer, and a second ferromagnetic layer that are disposed at interfaces between the antiferromagnetic layers and the upper electrode layer to strengthen the magnetic coupling between the antiferromagnetic layers and the upper electrode layer.

A magnetic disk apparatus according to the present invention includes a magnetic recording disk that is rotationally driven by rotational driving means, support means including a head suspension and a carrier arm that support a head slider on which a recording/reproduction head is formed, and a control unit that drives the support means to cause the head slider to carry out a seek operation, wherein the recording/reproduction head includes a CPP-type magneto-resistive head as a reproduction head, the CPP-type magneto-resistive head including: a magneto-resistive element; a lower electrode layer and an upper electrode layer disposed so as to sandwich the magneto-resistive element in a thickness direction; magnetic domain control layers that are disposed via insulating films on both sides of the magneto-resistive element and apply a bias magnetic field that controls a magnetic domain of a free layer provided in the magneto-resistive element; and antiferromagnetic layers that are laminated on the magnetic domain control layers and pin a bias magnetic field of the magnetic domain control layers.

With the magneto-resistive head according to the present invention, the production of noise such as Barkhausen noise is suppressed by providing the antiferromagnetic layers that are laminated on the magnetic domain control layers, so that a reproduction head that can operate stably can be provided. Also with a magnetic disk apparatus that uses this magneto-resistive head as a recording/reproduction head, it is possible to carry out stabilized and highly reliable recording/reproduction operations for information.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a cross-sectional view showing the construction of a magneto-resistive head according to the present invention;

FIG. 2 is a diagram useful in explaining the magnetic orientation of the magneto-resistive head;

FIGS. 3A to 3D are diagrams useful in explaining the manufacturing process of the magneto-resistive head;

FIGS. 4A to 4D are diagrams useful in explaining the manufacturing process of the magneto-resistive head;

FIG. 5 is a plan view showing the overall construction of a magnetic disk apparatus;

FIG. 6 is a perspective view of a head slider; and

FIG. 7 is a cross-sectional view showing a conventional construction of a magneto-resistive head.

### DESCRIPTION OF THE PREFERRED EMBODIMENTS

Preferred embodiments of the present invention will now be described in detail with reference to the attached drawings.

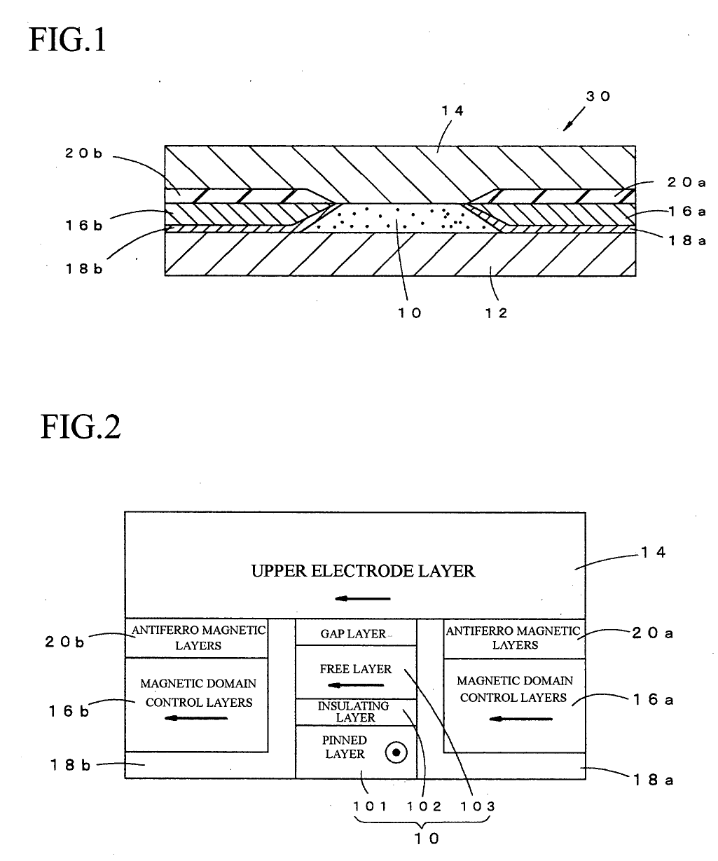

FIG. 1 shows the cross-sectional structure of a magneto-resistive head according to the present invention. Like the conventional magneto-resistive head shown in FIG. 7, the magneto-resistive head 30 according to the present embodiment includes a magneto-resistive element 10, a lower electrode layer 12, an upper electrode layer 14, and magnetic domain control layers 16a, 16b. Insulating layers 18a, 18b electrically insulate the magneto-resistive element 10 from the magnetic domain control layers 16a, 16b and the magnetic domain control layers 16a, 16b from the lower electrode layer 12.

It should be noted that the magneto-resistive element 10 is formed of a TMR (Tunneling MagnetoResistive) element including a pinned layer, an insulating layer, and a free layer or a spin valve-type GMR (Giant MagnetoResistive) element including a pinned layer, a non-magnetic intermediate layer, and a free layer. Due to the effect of the bias magnetic field applied by the magnetic domain control layers 16a, 16b, the magnetic orientation of the free layer when no magnetic field is applied is oriented in a direction perpendicular to the magnetic orientation of the pinned layer. The magnetic orientation of the free layer rotates in accordance with magnetization by the magnetic information recorded on a magnetic recording medium, and changes in the resistance of the magneto-resistive element 10 are detected using the lower electrode layer 12 and the upper electrode layer 14.

The characteristic structure of the magneto-resistive head 30 in the present embodiment is that antiferromagnetic layers 20a, 20b are laminated on the magnetic domain control layers 16a, 16b disposed on both sides of the magneto-resistive element 10. The antiferromagnetic layers 20a, 20b are provided to pin the bias magnetic field of the magnetic domain control layers 16a, 16b in a direction that aligns the magnetic orientation of the free layer formed on the magneto-resistive element 10 with a direction (the core width direction) perpendicular to the magnetic orientation of the pinned layer.

Since the antiferromagnetic layers 20a, 20b are provided, the upper electrode layer 14 is provided so as to cover the upper surface of the magneto-resistive element 10 and the upper surfaces of the antiferromagnetic layers 20a, 20b.

FIG. 2 is a diagram useful in explaining the magnetic orientation for the magneto-resistive head shown in FIG. 1.

The magneto-resistive element 10 included in a CPP-type magneto-resistive head can be constructed in various ways, but as described above, a pinned layer 101, an intermediate layer 102, and a free layer 103 are provided as a basic structure.

The pinned layer 101 is composed of a magnetic layer whose magnetic orientation is pinned so that the magnetic orientation does not fluctuate according to the magnetism of a magnetic recording medium. An antiferromagnetic layer is provided as a lower part of the pinned layer 101 and the magnetic orientation of the pinned layer 101 is pinned by magnetic exchange-coupling. The pinned layer 101 is formed of a laminated structure of one or more of NiFe alloy, FeCo alloy, and a ferromagnetic layer together with a non-magnetic layer. The antiferromagnetic layer is formed of MnPt, MnPtPd, MnIr, MnFe, MnNi, NiO, or the like.

In the case of a TMR element, the intermediate layer 102 that is an insulating layer causes a tunneling of current when current flows between the lower electrode layer 12 and the upper electrode layer 14, with Al₂O₃, SiO₂, AlN, SiN, TiO, MgO, HfO, or the like being used. It should be noted that in the case of a GMR element, a non-magnetic layer instead of an insulating layer is used as the intermediate layer 102.

The free layer 103 is composed of a magnetic layer provided so that the magnetic orientation of the free layer 103 is rotated by the magnetic orientation of the magnetic recording medium. The free layer 103 is formed of a single film or multiple films using NiFe alloy, FeCo alloy, or the like.

As described above, the magnetic domain control layers 16a, 16b are used to apply a bias magnetic field that orients the magnetic orientation of the free layer 103 to a direction perpendicular to the magnetic orientation of the pinned layer 101. The magnetic domain control layers 16a, 16b are formed of a hard ferromagnetic material such as CoCrPt or CoPt, with the magnetic orientation of magnetic domain control layers 16a, 16b being set so as to produce a bias magnetic field that makes the magnetic orientation of the free layer 103 perpendicular to the magnetic orientation of the pinned layer 101.

The antiferromagnetic layers 20a, 20b act so as to pin the bias magnetic field produced by the magnetic domain control layers 16a, 16b. The antiferromagnetic layers 20a, 20b act so as to pin the bias magnetic field produced by the magnetic domain control layers 16a, 16b due to magnetic exchange coupling at the interfaces between the antiferromagnetic layers 20a, 20b and the magnetic domain control layers 16a, 16b that acts so as to align the magnetic domain control layers 16a, 16b in a single direction.

In this way, by providing the antiferromagnetic layers 20a, 20b, the problem of non-uniformity for the magnetic domain of the end surfaces of the magnetic domain control layers 16a, 16b that face the side surfaces of the magneto-resistive element 10 is improved, and the magnetic domain control layers 16a, 16b can orient the magnetic orientation of the free layer 103 more precisely.

The antiferromagnetic layers 20a, 20b also have an effect on the upper electrode layer 14 that is composed of a soft magnetic material in that the magnetic orientation of the upper electrode layer 14 at the interfaces with the antiferromagnetic layers 20a, 20b is aligned with the magnetic orientation of the magnetic domain control layers 16a, 16b.

That is, the antiferromagnetic layers 20a, 20b have an effect of orienting and keeping the magnetic orientation of the upper electrode layer 14 at the standard magnetic orientation of the free layer 103. As a result, the magnetic orientation of the free layer 103 is prevented from becoming unstable, the production of noise such as Barkhausen noise is suppressed, and a magneto-resistive head that operates stably can be provided.

It should be noted that to strengthen the magnetic coupling between the antiferromagnetic layers 20a, 20b and the magnetic domain control layers 16a, 16b, it is effective to interpose a ferromagnetic layer, a non-magnetic layer, and another ferromagnetic layer at the interfaces between the antiferromagnetic layers 20a, 20b and the magnetic domain control layers 16a, 16b. In the same way, to strengthen the magnetic coupling between the antiferromagnetic layers 20a, 20b and the upper electrode layer 14, it is effective to interpose a ferromagnetic layer, a non-magnetic layer, and another ferromagnetic layer at the interfaces between the upper electrode layer 14 and the antiferromagnetic layers 20a, 20b. The ferromagnetic material is an alloy including at least one of Ni, Fe, and Co and the non-magnetic material is a single film of Ru, Ir, Cu, or the like or an alloy film including such materials. Here, the two ferromagnetic layers are anti-ferromagnetically coupled by sandwiching the non-magnetic layer between the two ferromagnetic layers, so that the magnetic coupling can be strengthened.

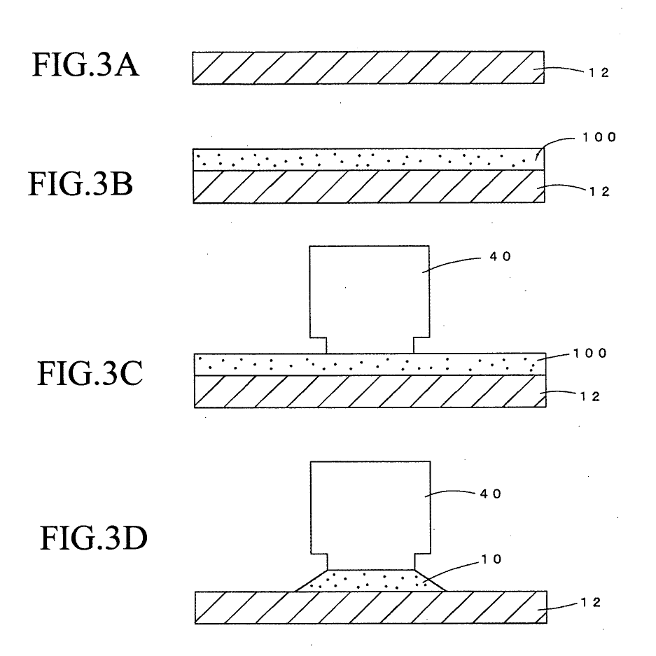

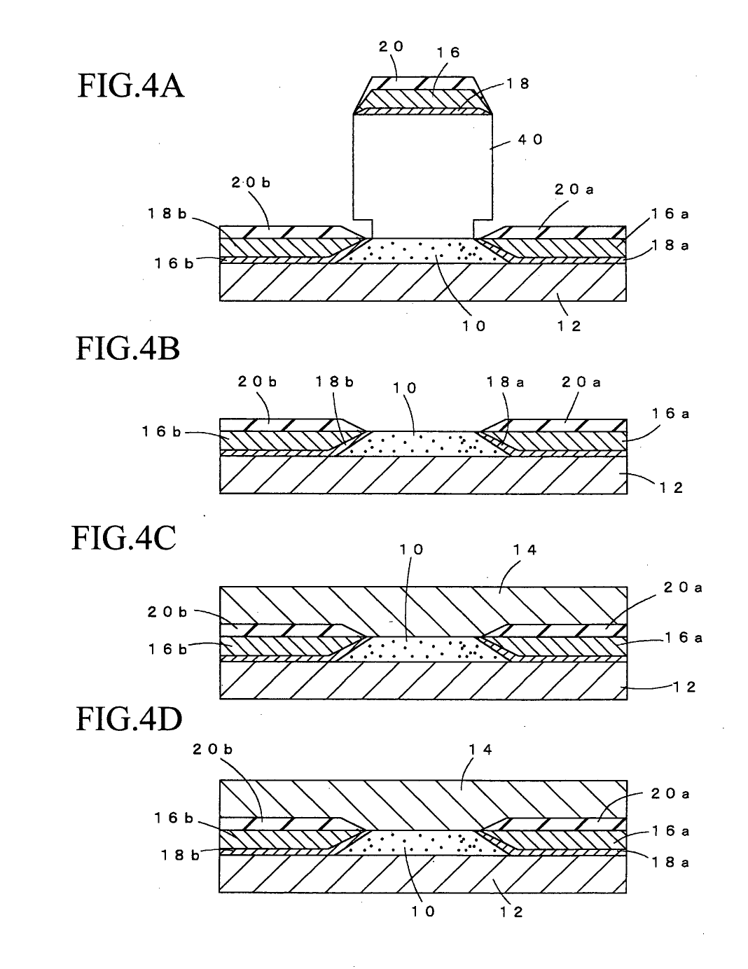

FIGS. 3A to 3D and FIGS. 4A to 4D show the manufacturing process of the magneto-resistive head described above. The method of manufacturing the magneto-resistive head is described below with reference to FIGS. 3A to 3D and FIGS. 4A to 4D.

FIG. 3A shows the state where the lower electrode layer 12 has been formed on a substrate (not shown) that forms the base of the magneto-resistive head. The lower electrode layer 12 is used as one of the current terminals, is also used as a magnetic shield of the magneto-resistive element 10, and is formed of a soft magnetic material. As one example, the lower electrode layer 12 can be formed by plating NiFe with a thickness of 1 to 2 μm. After plating, the surface of the lower electrode layer 12 is flattened by CMP (Chemical Mechanical Polishing).

After this, a magneto-resistive film 100 is formed on the surface of the lower electrode layer 12 (see FIG. 3B). The magneto-resistive film 100 is formed by laminating layers such as an anti-ferromagnetic layer, a pinned layer, an insulating layer, a free layer, and a gap layer in order by sputtering. The thickness of the magneto-resistive film 100 is around 50 nm. After the magneto-resistive film 100 has been formed, a pin annealing process is carried out to orient the magnetic orientation of the pinned layer 101 in a direction perpendicular to the floating surface.

FIG. 3C shows a state where a lift-off pattern 40 for forming the magneto-resistive element 10 by etching the magneto-resistive film 100 has been formed next. The lift-off pattern 40 is formed in an outwardly protruding shape by covering the surface of the magneto-resistive film 100 with a photosensitive resist and exposing and developing the resist.

FIG. 3D shows a state where the magneto-resistive film 100 has been etched by ion milling with the lift-off pattern 40 as a mask. By adjusting the angle of the ion milling, the side surfaces of the magneto-resistive element 10 are etched to become inclined surfaces.

FIG. 4A shows a state where the insulating layers 18a, 18b, the magnetic domain control layers 16a, 16b, and the antiferromagnetic layers 20a, 20b have been formed in that order in a state where the lift-off pattern 40 has been formed on the magneto-resistive element 10. The thickness of the insulating layers 18a, 18b is 5 to 20 nm, the thickness of the magnetic domain control layers 16a, 16b is 200 to 400 nm, and the thickness of the antiferromagnetic layers 20a, 20b is around 10 nm.

In the present embodiment, alumina is used as the insulating layers 18a, 18b, CoCrPt is used as the magnetic domain control layers 16a, 16b, and PdPtMn is used as the antiferromagnetic layers 20a, 20b.

By lifting off the lift-off pattern 40 after an insulating layer, a magnetic domain control layer, and the antiferromagnetic layer have been formed, the magneto-resistive element 10, the magnetic domain control layers 16a, 16b, and the antiferromagnetic layers 20a, 20b are left on the lower electrode layer 12, as shown in FIG. 4B. The insulating layers 18a, 18b are interposed at the interfaces of the magnetic domain control layers 16a, 16b with the magneto-resistive element 10 and the lower electrode layer 12.

FIG. 4C shows a state where the upper electrode layer 14 has been formed next on the surface of the magneto-resistive element 10 and the surfaces of the antiferromagnetic layers 20a, 20b. The upper electrode layer 14 is formed of a soft magnetic body, and as one example is formed by plating NiFe with a thickness of 1 to 2 μm.

Finally, an annealing process is carried out to magnetize the magnetic domain control layers 16a, 16b, the antiferromagnetic layers 20a, 20b, and the upper electrode layer 14 in a predetermined standard magnetic orientation (a direction perpendicular to the magnetic orientation of the pinned layer 101) for the free layer 103 (see FIG. 4D). This annealing process is carried out within a range where the magnetic orientation of the pinned layer 101 that is pinned in advance does not rotate.

By doing so, a magneto-resistive head constructed so that the respective parts have the magnetic orientations shown in FIG. 2 is obtained.

The magneto-resistive head described above constructs the reproduction head part of a recording/reproduction head used in a magnetic disk apparatus. The recording/reproduction head is obtained by forming a recording head on the magneto-resistive head described above. The recording head is composed of a coil and a magnetic yoke and is constructed so as to record information on a magnetic recording medium using an induced magnetic field produced by the coil. The recording head is formed by a well-known method, such as depositing films of magnetic material or the like.

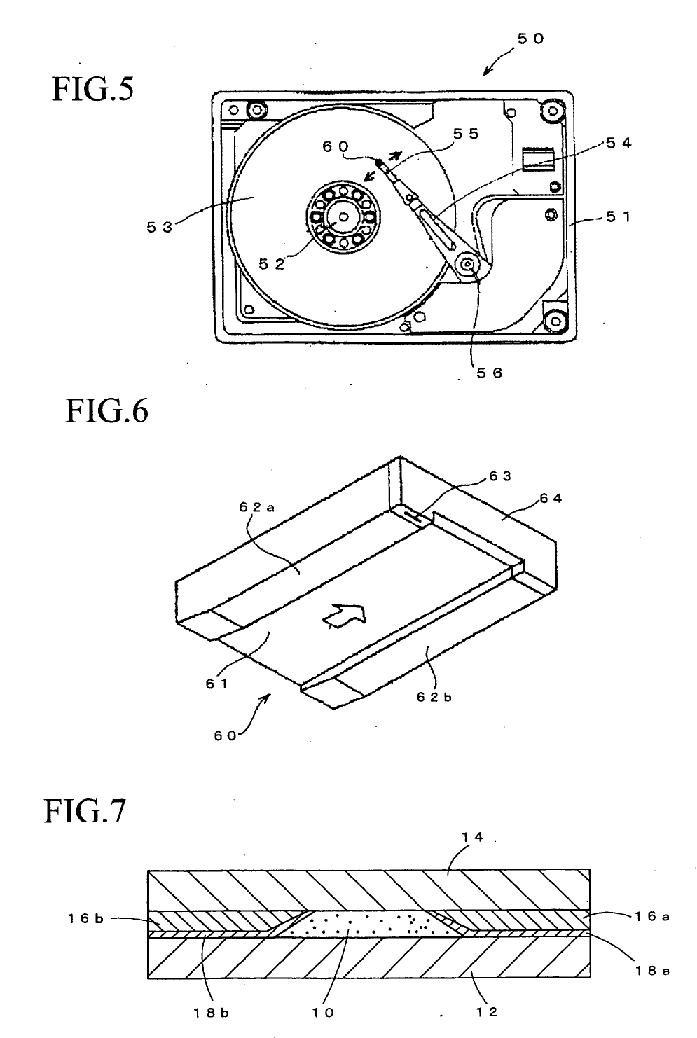

FIG. 5 shows one example of a magnetic disk apparatus that uses a recording/reproduction head including the magneto-resistive head described above. A magnetic disk apparatus 50 includes a plurality of magnetic recording disks 53 that are rotationally driven by a spindle motor 52 inside a casing 51 in the form of a rectangular box. Carriage arms 54 that are supported so as to be able to swing parallel to the disk surfaces are disposed beside the magnetic recording disks 53. Head suspensions 55 are attached to the ends of the carriage arms 54 so as to extend the carriage arms 54 and head sliders 60 are attached to the ends of the head suspensions 55. The head sliders 60 are attached to the surfaces of the head suspensions 55 that face the respective disk surfaces.

FIG. 6 is a perspective view of one of the head sliders 60. Floating rails 62a, 62b for causing the head slider 60 to float above the magnetic disk surface are provided along the side edges of a slider main body 61 on a surface (the ABS surface) of the head slider 60 that faces a magnetic disk. A recording/reproduction head 63 including a magneto-resistive head is disposed facing the magnetic disk at a front end (the side at which an air current flows out) of the head slider 60. The recording/reproduction head 63 is covered and protected by a protective film 64.

Each head slider 60 is elastically pressed toward a disk surface by the head suspension 55 and contacts the disk surface when rotation of the magnetic recording disks 53 is stopped. When the magnetic recording disks 53 are rotationally driven by the spindle motor 52, the respective head sliders 60 are caused to float by air currents produced by the rotation of the magnetic recording disks 53 and so move away from the respective disk surfaces. Information is recorded onto a magnetic recording disk 53 by the recording/reproduction head provided on the head slider 60. An operation that reproduces information is carried out by an operation (a seek operation) that swings the carriage arm 54 to a predetermined position using an actuator 56.

What is claimed is:

1. A CPP (Current Perpendicular to the Plane)-type magneto-resistive head comprising:
a magneto-resistive element;
a lower electrode layer and an upper electrode layer disposed so as to sandwich the magneto-resistive element in a thickness direction;
magnetic domain control layers that are disposed via insulating films on both sides of the magneto-resistive element and apply a bias magnetic field that controls a magnetic domain of a free layer provided in the magneto-resistive element; and
antiferromagnetic layers that are laminated on the magnetic domain control layers and pin a bias magnetic field of the magnetic domain control layers.

2. A CPP-type magneto-resistive head according to claim 1,
wherein the magneto-resistive element is a TMR element including a pinned layer, an insulating layer, and the free layer.

3. A CPP-type magneto-resistive head according to claim 1,
wherein the magneto-resistive element is a spin valve-type GMR element including a pinned layer, a non-magnetic intermediate layer, and the free layer.

4. A CPP-type magneto-resistive head according to claim 1,
wherein the antiferromagnetic layers are magnetically coupled to the magnetic domain control layers via a first ferromagnetic layer, a non-magnetic layer, and a second ferromagnetic layer that are disposed at interfaces between the antiferromagnetic layers and the magnetic domain control layers.

5. A CPP-type magneto-resistive head according to claim 1,
wherein the antiferromagnetic layers are magnetically coupled to the upper electrode layer via a first ferromagnetic layer, a non-magnetic layer, and a second ferromagnetic layer that are disposed at interfaces between the antiferromagnetic layers and the upper electrode layer.

6. A magnetic disk apparatus including a magnetic recording disk that is rotationally driven by rotational driving means, support means including a head suspension and a carrier arm that support a head slider on which a recording/reproduction head is formed, and a control unit that drives the support means to cause the head slider to carry out a seek operation,
wherein the recording/reproduction head includes a CPP-type magneto-resistive head as a reproduction head, the CPP-type magneto-resistive head comprising:
a magneto-resistive element;
a lower electrode layer and an upper electrode layer disposed so as to sandwich the magneto-resistive element in a thickness direction;
magnetic domain control layers that are disposed via insulating films on both sides of the magneto-resistive element and apply a bias magnetic field that controls a magnetic domain of a free layer provided in the magneto-resistive element; and
antiferromagnetic layers that are laminated on the magnetic domain control layers and pin a bias magnetic field of the magnetic domain control layers.
